(19) United States
(12) Patent Application Publication
(10) Pub. No.: US 2024/0399881 A1
(43) Pub. Date: Dec. 5, 2024

(54) DEVICE FOR INCREASING THE RANGE OF AN ELECTRIC VEHICLE BY RECOVERING ELECTRICAL ENERGY FROM AIR CURRENTS DURING DRIVING ON THE BASIS OF THE RELATIVE SPEEDS OF MOVEMENT BETWEEN THE TWO CONTACT MEDIA OF ELECTRIC VEHICLES, AND AN ELECTRIC VEHICLE WITH SUCH A DEVICE

(71) Applicant: DWT B.V., Mijdrecht (NL)

(72) Inventor: Johannes Maria Kruijt, Mijdrecht (NL)

(21) Appl. No.: 18/798,030

(22) Filed: Aug. 8, 2024

Related U.S. Application Data
(63) Continuation of application No. PCT/NL2023/050054, filed on Feb. 7, 2023.

(30) Foreign Application Priority Data
Feb. 8, 2022 (NL) 2030842

(51) Int. Cl. B60L 8/00

(52) U.S. Cl. CPC B60L 8/006

(57) ABSTRACT

An electric vehicle with a device, and the device itself, the device capable of converting air currents into electrical energy on board an electric vehicle. The device may be built into the grille of an electric vehicle. A first rotor has a first axis of rotation that is substantially vertical to the direction of travel of the vehicle. At least one inlet includes a first air inlet configured to direct a frontal airflow on the vehicle to a first lateral segment of the internal volume.

### CROSS-REFERENCE TO RELATED APPLICATIONS

This application is a continuation of International Patent Application No. PCT/NL2023/050054, filed Feb. 7, 2023, entitled “A DEVICE FOR INCREASING THE RANGE OF AN ELECTRIC VEHICLE BY RECOVERING ELECTRICAL ENERGY FROM AIR CURRENTS DURING DRIVING ON THE BASIS OF THE RELATIVE SPEEDS OF MOVEMENT BETWEEN THE TWO CONTACT MEDIA OF ELECTRIC VEHICLES, AND AN ELECTRIC VEHICLE WITH SUCH A DEVICE”, which claims priority to and the benefit of Netherlands Patent Application No. 2030842, entitled “A DEVICE FOR INCREASING THE RANGE OF AN ELECTRIC VEHICLE BY RECOVERING ELECTRICAL ENERGY FROM AIR CURRENTS DURING DRIVING ON THE BASIS OF THE RELATIVE SPEEDS OF MOVEMENT BETWEEN THE TWO CONTACT MEDIA OF ELECTRIC VEHICLES, AND AN ELECTRIC VEHICLE WITH SUCH A DEVICE”, filed Feb. 8, 2022, and the specifications and claims thereof are incorporated herein by reference.

### BACKGROUND OF THE INVENTION

### Field of the Invention

The invention relates to a device for converting air currents into electrical energy on board an electric vehicle.

### Background

The grille of a vehicle is the common name for a part of the nose or front of a car. In a vehicle with a combustion engine, the grille is also the name for the part that takes in wind while driving in order to cool the engine, such is a nose grille. However, there is no such cooling to speak of in an electric vehicle. The nose of such vehicle is usually characterized by a grille, in the form of a nose grille and/or an intake, and where the nose also has a (engine) hood. The inlet then exits under the hood in a dead space. A dead space is a name for the residual space under the hood, also known as the headspace. In electric vehicles, such spaces are quite large, because the usual cooling systems for an internal combustion engine do not have to be present. Such a grille (and sometimes also the intake) is actually unnecessary in electric vehicles, but remains present because of the familiar appearance that makes a tough and sporty impression on the consumer. However, this aesthetic choice creates unnecessary drag on the vehicle while driving. In some vehicles, therefore, an air stream unnecessarily enters the nose of the vehicle, after which it is scattered therein. In other cases, a flat plate is placed behind the grille, so that the air breaks through the grille and then hits said plate. Unnecessary resistance also arises when such air flows past the vehicle via the grille, because it again has to exit the grille or the inlet along the lateral edges thereof. In air the driving resistance is sometimes tens of percent higher than is necessary for the vehicle. Such a loss therefore translates into a reduction in the range of the electric vehicle. There is a desire within the automotive industry to maintain the familiar look, but to reduce losses.

In addition to reducing losses, relative speed differences between contact media of the vehicle can under certain circumstances serve to generate electrical energy. For example, if a vehicle has a headwind while driving, and this wind is not stationary in relation to the road, then the vehicle can in principle use this airflow to accelerate the vehicle from a standstill against the same airflow, by gaining energy from the relative speed between the two contact media. One can think of a windmill on wheels. However, an energy gain can also be achieved when the vehicle moves faster than a tailwind. This principle is known from the American Physics Olympiad: “AAPT United States Physics Olympiad Semifinal Exam” from 2013 [https://ve42.co/AAPT2013]. In this example, the ambient wind drove a turbine, namely a propeller, which through a transmission on the wheels ensured that the vehicle could accelerate well beyond the wind speed. So into the wind from the vehicle's perspective. The phenomenon of using relative air currents to convert wind energy into kinetic energy has also been investigated by the research group ‘Veritasium’ who broadcast their studies on YouTube [https://www.youtube.com/watch?v=yCsgoLc_fzl&t=897s]. In this study, the well-known Veritasium research group confirmed the findings of Md. Sadak Ali Khan, Syed Ali Sufiyan, Jibu Thomas George, Md. Nizamuddin Ahmad. Analysis of Down-Wind Propeller Vehicle. International Journal of Scientific and Research Publications, 3, 4. (April 2013) ISSN 2250-3153 (www.ijsrp.org). A similar principle is also known from the world of sailing, where the relative speed of the wind relative to the water enables a sailing vessel to sail faster than the wind. ‘Bauer, A. B. (1969 April), Faster than the Wind. In First AIAA Symposium on Sailing.’ [https://ve42.co/Bauer1969].

### BRIEF SUMMARY OF THE INVENTION

The present invention (a) uses the unnecessary friction losses due to the aesthetic design of the nose or (b) makes use of a physical phenomenon to utilize the relative speed between the two contact media of the vehicle for the propulsion of the vehicle. The present invention thus aims to increase the range of electrically driven vehicles. Electric vehicles can also be understood as hybrid vehicles, or any other vehicle that provides its propulsion based on electrical energy. Vehicles here are mainly passenger vehicles, such as cars, but also comprise trucks and (delivery) vans.

For the aforementioned reason, a first aspect of the invention provides a device designed to be built in behind the grille in a dead space under the front cover of an electric vehicle. The front cover is also referred to as the car hood. The at least one rotor anyway comprises a first rotor provided with rotor blades and this has a first axis of rotation which is substantially vertical to the vehicle. The at least one inlet herein comprises a first inlet configured to direct a frontal airflow on the vehicle to a first lateral segment of the internal volume. The first rotor can then, for instance, have a larger diameter than a wheel of the vehicle. The ability to install the device behind the grille of an electric vehicle generally follows from the width-to-height ratio of the housing, which is always wider than it is high. The housing with a height-to-width ratio of about 1:2 to about 1:6 is advantageous due to its compact fit with the headspace, or residual space, within the nose of the electric vehicle. Preferably the ratio is about 1:3 to about 1:5. The advantage of the latter ratio is that it can also be easily mounted in the residual space of most existing vehicles, without the need for a substantial re-arrangement, and therefore redesign, of the internal layout of otherwise present components behind the grille. By the way, the term substantially vertical can be seen as 80-100 degrees, preferably perpendicularly upwards, to the longitudinal axis of the vehicle.

The rotation of the at least one rotor can have unintended gyroscopic effects. The at least one rotor can therefore also comprise a second rotor with a second axis of rotation parallel to the first axis of rotation. The first and second rotor can then be designed both concentrically and non-concentrically within the housing. However, the non-concentric version facilitates counter rotation by mechanically coupling the axes of the rotors, allowing the gyroscopic effects to cancel each other out. The rotors can thus be arranged to rotate together in opposite directions.

Where air from different face halves of the grille is admitted by means of a single wide inlet and supplied directly to the at least one rotor, the problem arises that the air from one face half can blow against the direction of rotation of the rotor. For the aforementioned reason, at least one air inlet can therefore be supplied at an angle tangentially to the first rotor. Optionally, it is also possible that the at least one air inlet comprises a second air inlet which is then arranged to direct a frontal airflow on the vehicle to a second lateral segment other than the first segment of the internal volume. In this case, it is then also possible, for example, to ensure that the first and second inlets each supply the air in a tangential direction to the first rotor and second rotor, respectively.

In order to ensure that the air flows from different inlets to different rotors cooperate, the first and second rotor can be designed one below the other in parallel planes. The at least one air outlet then also comprises a first air outlet and a second air outlet. The path of the airflow from the first inlet through the first rotor to the first outlet, and the path of the airflow from the second inlet through the second rotor to the second outlet may then cross over each other within the internal volume.

To prevent any scattering from the different air flows within the internal space, and to increase the performance of the device, the first and second rotor may each comprise a disc with rotor blades projecting axially from said disc. Each disc then extends radially toward a lateral inner wall of the housing such that the air paths through the rotors are substantially fluidly separated by a gap extending between opposing disc surfaces of the first and second rotors.

Optionally, a shaft part of the first and a shaft part of the second rotor extend into the intermediate space, the shaft parts being designed to form a transmission, such as a gear transmission. This protects the transmission against external influences.

The size and shape of the available residual space, also known as the empty space, within the nose varies from vehicle to vehicle. To make optimal use of irregular shapes, it is possible to design the first rotor with a larger diameter than the second rotor. The first rotor can then be designed above the second rotor within the housing or vice versa. So that a recess can be made in the otherwise mainly cylindrical housing to the size of the difference in diameter between the rotors. In this way the device can be placed around protruding components of the vehicle without effective loss of function. Any transmission between the rotors can be adjusted in such a way that the rotational speed of the air resistance is substantially equal for both rotors, preferably for an airspeed of 100 km/h for optimum operation.

To increase the efficiency of the device, one can cause the at least one air inlet, e.g. the first as well as the second inlet, to converge towards the housing. The same can be done for the at least one air outlet, such as the first and second outlets.

The rotational speed of the rotor can be inversely proportional to the mechanical air resistance of the device at a fixed driving speed and fixed wind speed. When the rotors have reached their maximum speed at a certain speed, the friction through the rotors will mainly consist of the resistance that the generator exerts on the rotors to generate electrical energy. Optionally, the generator resistance could be tuned to the extra resistance that the vehicle would experience without the device. The device can thus be limited to a rotational speed range within which driving the device is electrically profitable and increases the range of the vehicle. In an example of the foregoing, the device may comprise a sensor for measuring the rotational speed of the at least one rotor, the device being configured to adjust the resistance of the generator to limit the at least one rotor to a predetermined rotational speed range. For example, the device may be equipped with a control unit, such as a processor, which is communicatively connected to the sensor and the generator. Alternatively, the vehicle's central processing unit, also referred to as the CPU, may be configured to do the same as the control unit.

In another example, the vehicle may be equipped with an airspeed meter. An example of an airspeed meter is a Pitot tube meter, but those skilled in the art will know that there are many different options for measuring relative airspeed at the vehicle. A vehicle itself will also have a vehicle speed sensor, also known as a VSS. The VSS normally measures transmission power and wheel speed. In this example, the device combines information from the VSS and the airspeed meter to determine the relative speed difference between the contact media of the vehicle. Based on this difference, the rotation of the at least one rotor can be tuned to maximize electrical output. The rotational speed of the at least one rotor is controlled by the amount of electrical energy drawn from the generator.

Additionally and/or alternatively, the at least one inlet may be provided with a reversible closure to open the device to the air currents only within a predetermined speed range of the vehicle, such as between 80-130 km/h. Optionally, by means of the sensor, the central processing unit can then determine whether the device is electrically profitable. If this is not the case, the central processing unit controls the closure to temporarily isolate the device from the air flow. The system can then automatically open the closure again after a predetermined interval, and repeat the determination.

Finally, it is also not inconceivable that the residual space in an electric vehicle takes on a particularly complicated shape. As a result, a simple cylindrical design with one or two rotors cannot be made to fit. In such a case, for example, three rotors of mutually different sizes can be provided. For example, the device can then be made to fit the residual space step by step, more so than is the case with two rotors of mutually different sizes. The device can thus be designed with a third rotor, such as of mutually different size with the first and/or second rotor, the third rotor being co-rotating with the first and/or second rotor, and the device being designed to supplying a frontal airflow to the third rotor and exhausting it from the third rotor, and optionally wherein the airflow over the third rotor is separated from the airflow over the first and/or second rotor. A separate inlet for the third rotor can be provided for this purpose, or the inlet to the first or second rotor can include a splitter that divides the airflow to the respective rotors.

According to a second aspect of the invention, an electric vehicle is provided comprising:
a grille with a dead space behind it under a front hood; and
the device according to the first aspect of the invention, implemented within the void space,
   wherein the vehicle is provided with a battery and inverter for storing, in use, the electrical energy generated by the device in the battery. If necessary, the battery can be charged using the standard battery management system, also known as the BMS.

Optionally, the at least one air outlet opens out on one or more lateral sides of the nose of the vehicle. If there is a first and a second air outlet, these preferably open on opposite lateral sides. The outlet is further preferably designed in such a way that it converges towards the mouth, such that, in use, an air jet with a directional component is created against the direction of travel of the vehicle.

Optionally, the first rotor has a larger diameter than each of the vehicle's driving wheels. This option is also possible in combination with any feature according to the first aspect of the invention and subsequent options. In this way, the system can run entirely on the kinetic energy of the rotor, until such energy is exhausted and insofar as such energy is insufficiently replenished by the kinetic energy of the air currents to maintain the rotation of the at least one rotor. Optionally, the electrical resistance of the generator can be adjusted to a constant speed of the vehicle, such as 100 km/h, or other speeds.

In addition to the loss of range, the aesthetic preservation of an open grille in electric vehicles also has disadvantages in the event of frost. At low temperatures, such as below freezing point in winter, ice can build up in the empty space under the hood. This is generally not a nuisance, but in moving systems, such as a device according to the invention, it may lead to a restriction of function. There is therefore a demand for an anti-frost option. Some of these options will be discussed below. In one example, to combat icing, a vehicle cooling system normally present, such as a cooling water system for the vehicle's electric motor and/or battery, may serve to dissipate heat in use, i.e. while the vehicle is being driven, to part of the device so as to reduce the chance of ice build-up within at least part of the device. This version is compatible with all versions of the device. In a specific embodiment, the at least one air inlet and/or the housing is designed as a heat exchanger with the cooling system. Alternatively, part of the recovered electrical energy can be used to heat at least part of the device at sub-zero temperatures. The device can herein be provided with an electric heating element. The aforementioned anti-frost options can be switched on and off via manual operation, or by means of a thermal sensor of the vehicle that measures the temperature of the outside environment or the air taken in by the device or both. In case a thermal sensor is used then a predetermined temperature threshold, such as 0 degrees Celsius, can be used to activate the anti-freeze option or options.

In order to simplify maintenance of the device, the housing, with the at least one rotor fitted therein, can comprise coupling parts with which it is designed to be reversibly disconnectable from:
the at least one air inlet (8, 9);
the at least one air outlet (10, 11); and optional
the electric generator (G).

The most wear and maintenance-sensitive components, namely the moving components, can be replaced by a simple operation. When installing in a vehicle, for maintenance, you only need to disconnect the housing and replace and connect a cleaned or new version of the system. It is also possible to reinstall an updated version of the system, for example when the systems undergo an improvement. The coupling parts can be designed as a click system for simplicity. If the electric generator remains attached to the housing, it can be fitted with an electricity cable that itself can be disconnected, for example by being equipped with a Multi plug.

Another aspect of the invention is directed to a device for converting air currents into electrical energy on board an electric vehicle comprising: a housing defining an internal volume; at least one rotor carried in the internal volume; at least one air inlet in fluid communication with the internal volume for the input of a frontal airflow against a direction of travel of the vehicle, at least one air outlet in fluid communication with the internal volume for the outlet of the airflow; and an electrical generator configured to convert kinetic energy of the at least one rotor into electrical energy.

Reference to a “first” and “second” etc. aspect or embodiment of the invention is not intended to mean that any one particular embodiment is a preferred embodiment.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic illustration showing a cross-section of a first embodiment of the device according to an embodiment of the present invention;

FIG. 2 is an illustration from a top view showing a plan view of an electric vehicle with the device according to the first embodiment;

FIG. 3 is an illustration from a front view showing an electric vehicle according to FIG. 2;

FIG. 4 is an illustration showing a schematic cross-section of a second embodiment of the device according to an embodiment of the present invention;

FIG. 5 is an illustration from a top view showing a plan view of an electric vehicle with the device according to the second embodiment; and

FIG. 6 is an illustration from a font view showing an electric vehicle according to FIG. 5.

### DETAILED DESCRIPTION OF THE INVENTION

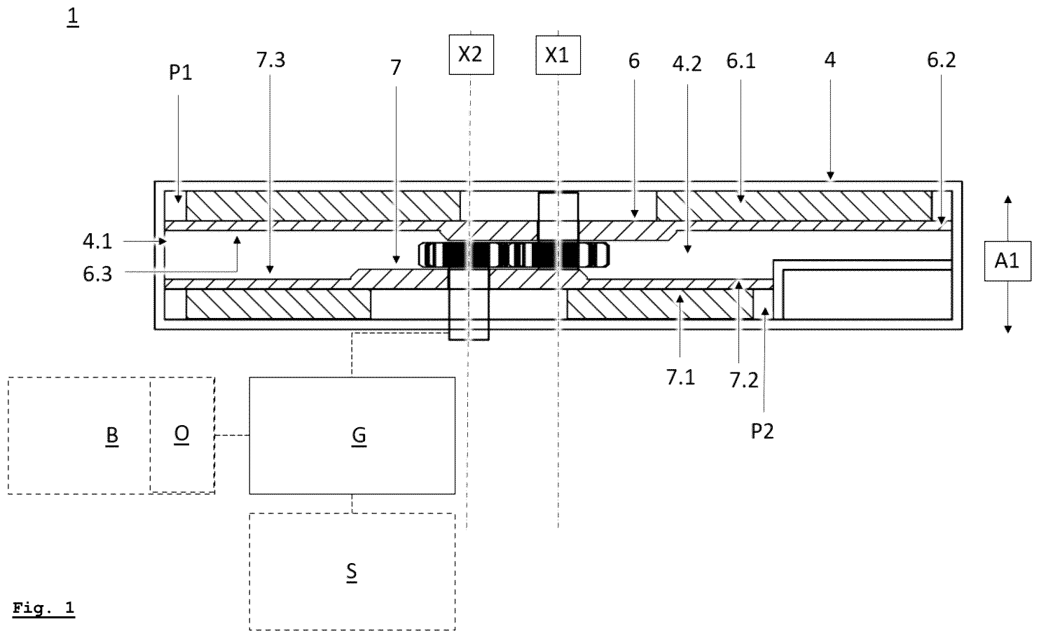

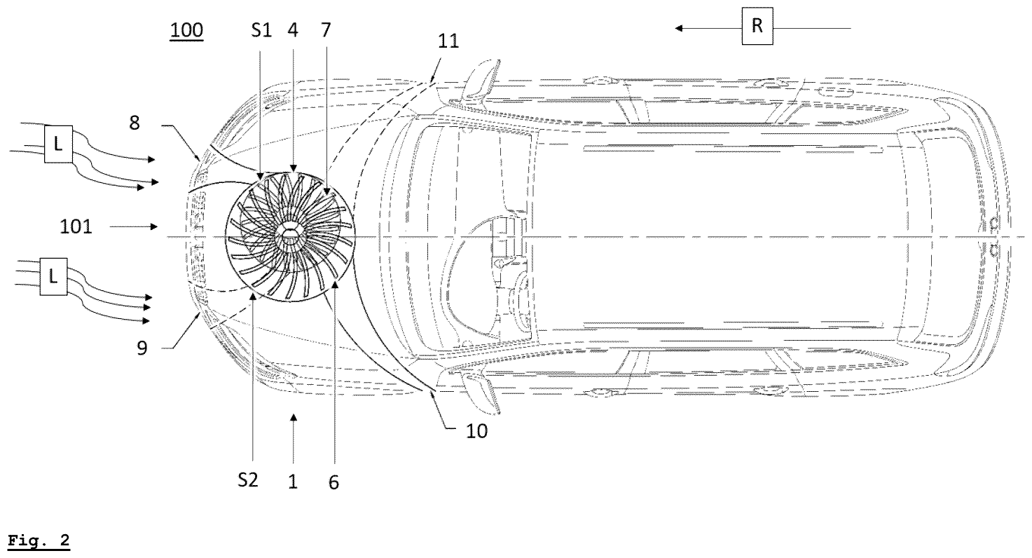

FIG. 1 shows device 1 according to a first embodiment for converting air currents L shown in FIG. 2 into electrical energy on board electric vehicle 100, also shown in FIG. 2. The device according to FIG. 1 has housing 4 defining an internal volume. This internal volume, or inner space, consists of two joined cylindrical sub-volumes, also known as sub-spaces, where each cylinder is wider than it is high. In this example, the two cylindrical sub-spaces are different in diameter, but they can also be the same or different in height. In this example, only first and second rotor 6, 7 are designed within the internal space. However, more rotors are also possible. The two rotors are superimposed and spaced apart within the housing. The rotors differ from each other in the same way as the sub-spaces, namely in diameter. For example, the internal diameter of the sub-spaces substantially corresponds to the diameter of the corresponding rotor. In this way the rotors are matched with the housing. The first and second rotor are of non-concentric design and have first rotational axis X1 and second rotational axis X2, respectively. These axes are parallel to each other and even mesh with each other to transfer rotational forces to each other. For this, gears or other transmission are provided on the shafts. This way the rotors can co-rotate in opposite directions. Optionally, the gear wheels or other transmission can be designed to achieve the same air displacement by means of co-rotation. To this end, the gears can be designed with different numbers of teeth, so that a smaller rotor, here second rotor 6, of the two rotors always rotates faster than a larger rotor, here second rotor 7. The rotors are each designed as a discus 6.2, 7.2 with rotor blades 6.1, 7.1 projecting in axial direction A1 from the discus. In this example, rotor blades 6.1 of first rotor 6 extend upwards, and rotor blades 7.1 of the second rotor extend downwards. The disc of each rotor extends until it meets a corresponding lateral inner wall 4.1 of the housing. The discus extend almost all the way to the wall, but do have a slit (not shown, but usual) to avoid running into the wall. This gap can be, for example, 0.1-2 mm. In this way the air flows over first and second rotor 6, 7 are separated. The second rotor is inverted with the first rotor, creating gap 4.2 between the two opposing disc surfaces 6.3, 7.3 of the first and second rotors 6, 7. In this example, the second rotor is connected to electric alternating current generator G, but this could of course also have been the first rotor, because the first and second rotor are of co-rotating design. The alternating current can then be easily converted to direct current by means of inverter O to charge battery B. In this case, the inverter and battery are optional, and in many cases already present in the electric vehicle. Optional components or compounds within this particular embodiment are indicated with a dotted line - - - . The dashed lines -.-.- represent an axes. The device may comprise a sensor, which may be connected to the generator, since rotational speeds of the rotors are proportional to the generated voltage. The sensor can then determine, based on the generated power, what the speed is at a certain rotational resistance, also known as the electromagnetic resistance, of the generator. Alternatively, sensor S may be provided to one of the rotors and the housing to detect rotation on the rotors. The sensor may be a conventional rotation sensor known per se. Optionally, the generator may be arranged to limit the at least one rotor to a predetermined rotational speed range, i.e. to a predetermined power range.

FIG. 2 shows the device as installed in vehicle 100. The device here clearly has first and second air inlet 8, 9 which are each in fluid communication with a corresponding sub-volume of the internal volume. In this example, the air inlets are furnished at the grille, for example behind a grille of the vehicle in order to receive a relative airflow L in the direction of travel R of the vehicle. The inlets converge towards the internal volume to blow a jet of air at a higher speed over the corresponding rotors. These air jets are deliberately not directed at the center of the rotor, but the inlet is directed to introduce the jet into first lateral segment S1 or second lateral segment S2 such that the air jet has a tangential component on the corresponding rotor. As a result, the device can also be able to drive the rotors at lower speeds. The rotors can be aluminum or stainless steel. The air sample can then expand again within the internal volume, so that an optimum distribution of the air over the rotor blades is achieved. It can also be seen that device 1 has first and second air outlet 10, 11 which are also in fluid communication with the internal volume, downstream of the corresponding inlet. First inlet 8 corresponds to first outlet 10 via first rotor 6, and the second inlet corresponds to second outlet 11 via second rotor 7. In this way, there is respectively first path P1, and second path P2 (also indicated in FIG. 1) that are not in fluid communication with each other, but do cross over each other within the internal volume. The first and second outlets each open on opposite lateral sides of the nose.

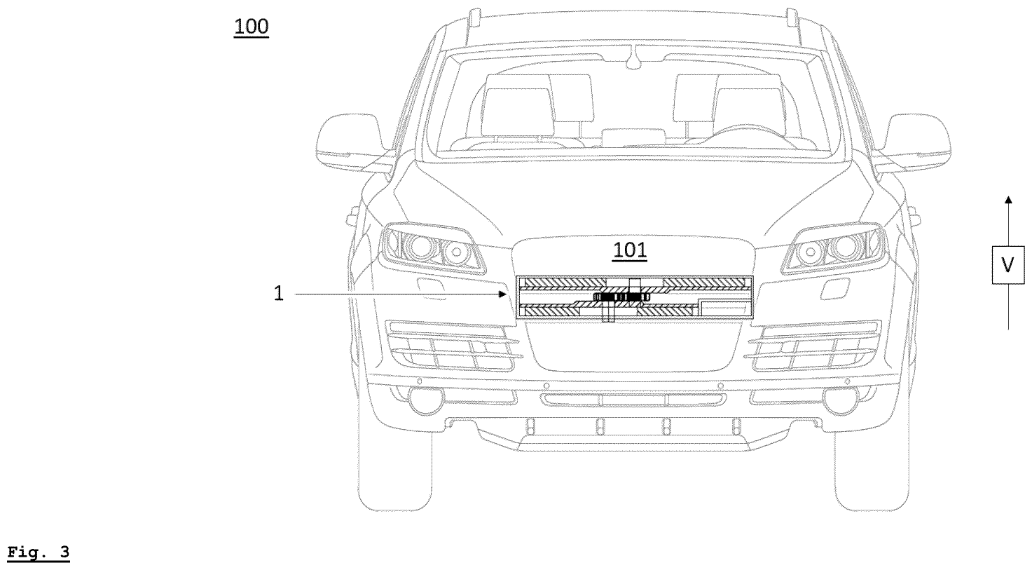

FIG. 3 shows how compact the device is in relation to the grille.

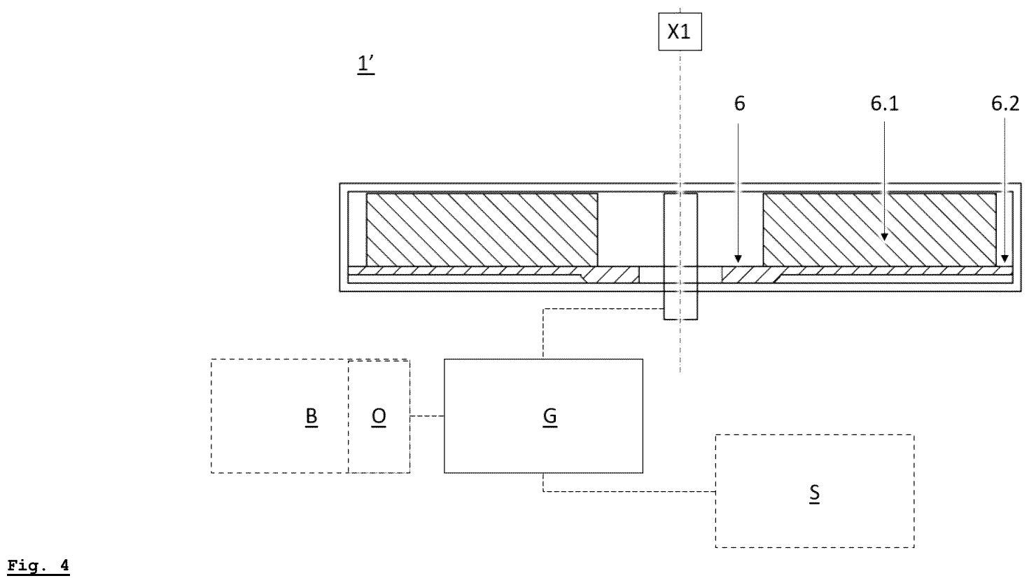

FIG. 4 shows second embodiment of device 1′ according to an embodiment of the present invention. Only differences are discussed below with device 1 according to FIG. 1. Components with the same number refer to the same feature. In the example of FIG. 1, device 1′ is only designed with first rotor 6. This makes the device according to FIG. 4 the simplest design with the fewest number of moving parts. The embodiment according to FIG. 1 is therefore less susceptible to defects. In this example, housing 4 is substantially cylindrical. The same applies to the internal volume which mainly fits with the first rotor.

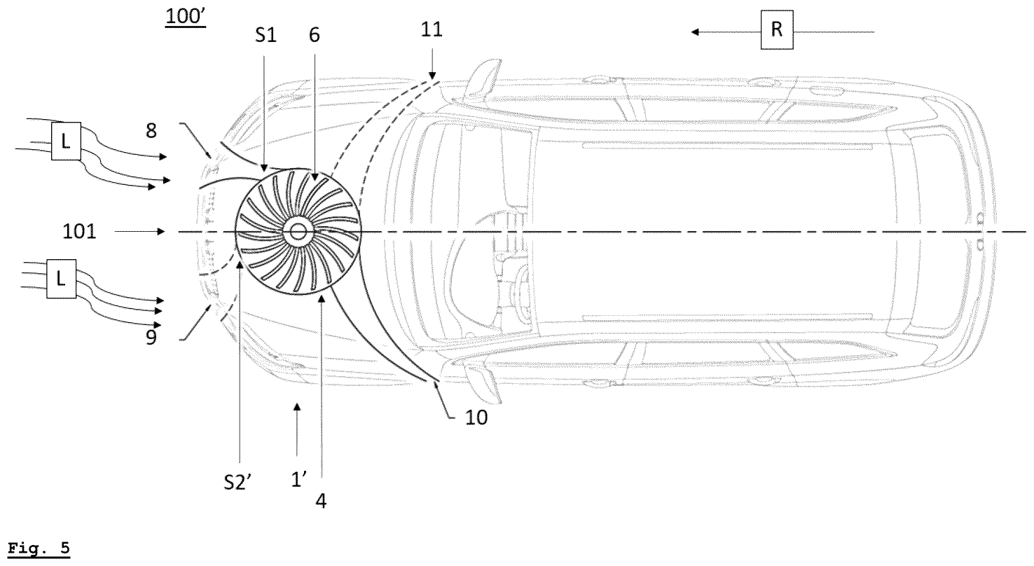

FIG. 5 shows device 1′ in another electric vehicle 100′. In this example, optional components are indicated with a dotted line - - - . It will therefore be clear that the device only needs first inlet 8 and first outlet 10. Optionally, however, second inlet 9 can also, in use, blow into the same first rotor. This second inlet then curves along with the direction of rotation of the first rotor to deflect the frontal airflow in the direction of rotation of the first rotor.

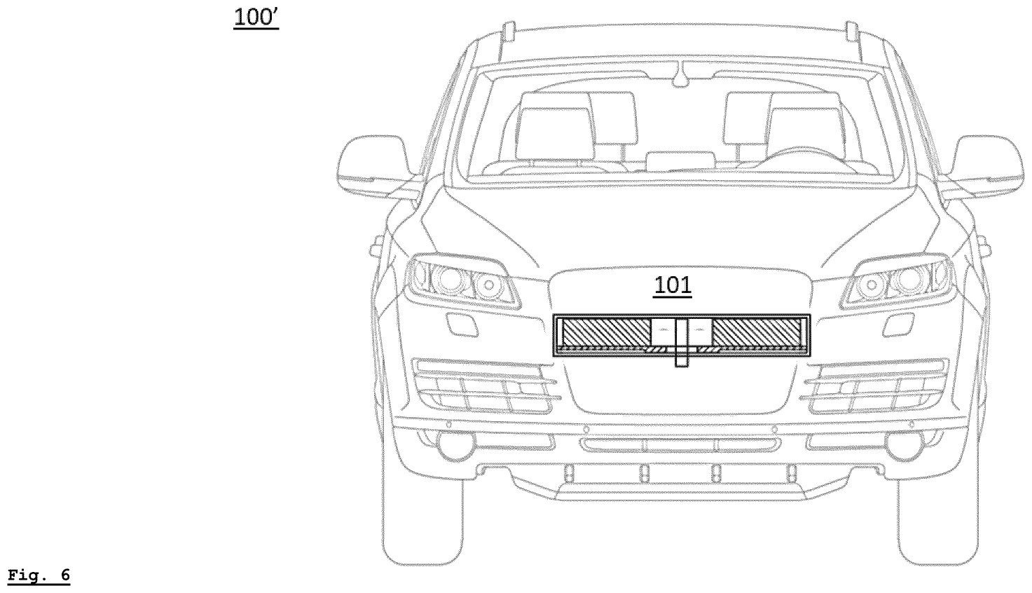

FIG. 6 again shows how compact device 1′ is in relation to grille 101.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

Note that in the specification and claims, “about” or “approximately” means within twenty percent (20%) of the numerical amount cited.

What is claimed is:

1. A device for converting air currents into electrical energy on board an electric vehicle, comprising:
a housing defining an internal volume;
at least one rotor arranged in the internal volume;
at least one air inlet in fluid communication with the internal volume for the introduction of a relative airflow against a direction of travel of the vehicle;
at least one air outlet in fluid communication with the internal volume for the outlet of the air stream; and
an electric generator arranged to convert kinetic energy of the at least one rotor into electrical energy, wherein the device is designed to be built in behind the grille within a dead space under the front cover of an electric vehicle, wherein the at least one rotor comprises a first rotor provided with rotor blades having a first axis of rotation which, in use, is substantially vertical to the direction of travel of the vehicle, and in which the at least one inlet comprises a first air inlet configured to direct a frontal airflow on the vehicle to a first lateral segment of the internal volume.

2. The device according to claim 1, wherein the at least one rotor also comprises a second rotor with a second rotational axis parallel to the first rotational axis, and wherein the first and second rotor are of non-concentric design within the housing.

3. The device according to claim 1, wherein the at least one air inlet further comprises a second air inlet configured to direct a frontal airflow on the vehicle to a second lateral segment, different from the first segment of the internal volume.

4. The device according to claim 3, wherein the at least one air outlet comprises a first air outlet and a second air outlet, and wherein the path of the airflow from the first inlet through the first rotor to the first outlet, and the path of the airflow from the second inlet through the second rotor to the second outlet cross over each other within the internal volume.

5. The device according to claim 3, wherein the first and second rotors each comprise a disc with rotor blades projecting in an axial direction from the disc, and each disc extends to a lateral inner wall of the housing such that an airflow through the first rotor and an airflow through the second rotor are substantially fluidly separated by a gap extending between opposing disc surfaces of the first and second rotors.

6. The device according to claim 2, wherein the first and second rotor are co-rotating in opposite directions.

7. The device according to claim 5, wherein a shaft part of the first and a shaft part of the second rotor extend into the interspace, the shaft parts being arranged to form a transmission, such as a gear transmission.

8. The device according to claim 2, wherein the first rotor has a larger diameter than the second rotor, and wherein the first rotor is arranged above the second rotor in the housing or vice versa.

9. The device according to claim 1, wherein the at least one air inlet converges towards the housing, and wherein the at least one air outlet diverges towards the housing.

10. The device according to claim 2, wherein the at least one rotor comprises a third rotor which is co-rotating with the first and/or second rotor, and wherein the device is configured to supply a frontal airflow to the third rotor and exhaust it from the third rotor, and wherein the airflow over the third rotor, in use, is supplied separately or split from the airflow over the first and/or second rotor.

11. The device according to claim 1, comprising a sensor for measuring the rotational speed of the at least one rotor, the device arranged to adjust the resistance of the generator to limit the at least one rotor to a predetermined rotational speed range.

12. The device according to claim 1, designed to be connected to a cooling system of the electric vehicle, such as a cooling water system for the electric motor and/or battery of the vehicle, to transfer heat to a part of the device during use.

13. The device according to claim 1, wherein the housing, with the at least one rotor arranged therein, comprises coupling parts with which it is designed to be reversibly detachable from:
the at least one air inlet; and
the at least one air outlet.

14. An electric vehicle comprising:
a grille with a dead space behind it under a front cover; and
the device according to claim 1, arranged behind the grille within said dead space, the vehicle comprising a battery and inverter to, in use, store the electrical energy generated by the device in said battery.

15. The vehicle according to claim 14, wherein the at least one air outlet debouches to one or more lateral sides of the nose of the vehicle.

16. The vehicle according to claim 14 characterized in that the first rotor has a larger diameter than each of the wheels with which the vehicle is driven.

17. The device according to claim 1, wherein the housing, with the at least one rotor arranged therein, comprises coupling parts with which it is designed to be reversibly detachable from the electric generator.
